(19) United States
(12) Patent Application Publication
(10) Pub. No.: US 2013/0241367 A1
(43) Pub. Date: Sep. 19, 2013

(54) EXCITER OF A ROTARY ELECTRIC MACHINE

(71) Applicant: DENSO CORPORATION, Kariya-city (JP)

(72) Inventor: Makoto TANIGUCHI, Obu-shi (JP)

(73) Assignee: DENSO CORPORATION, Kariya-city (JP)

(21) Appl. No.: 13/845,493

(22) Filed: Mar. 18, 2013

(30) Foreign Application Priority Data
Mar. 19, 2012 (JP) 2012-062202

(51) Int. Cl. H02K 11/00

(52) U.S. Cl. CPC H02K 11/0094
USPC 310/68 D

(57) ABSTRACT

Segments formed by dividing a core equally in a circumferential direction are constituted by laminating a plurality of magnetic steel sheets, and each of the segments has an inner wall part, an outer wall part, and a base part. The inner wall part and the base part are constituted by laminating substantially L-shaped magnetic steel sheets in the circumferential direction of the segment. The outer wall part has, when seen from the axial direction, a shape of an arc that has an equal distance from a center of the core, and is constituted by laminating the magnetic steel sheets, which are bent into an arc-shape, in the radial direction of the segment. The outer circumference end part of the base part is inserted into a recessed portion recessed in the outer wall part, and is fixed.

### CROSS-REFERENCE TO RELATED APPLICATION

The application is based on and claims the benefit of priority from earlier Japanese Patent Application No. 2012-62202 filed Mar. 19, 2012, the description of which is incorporated herein by reference.

### TECHNICAL FIELD

The present disclosure relates to a rotary electric machine for household appliance, industrial use, and movable bodies, and especially relates to an exciter of the rotary electric machine suitable as a generator motor for automobiles having a rotor with field windings.

### BACKGROUND

Although a small and highly efficient brushless motor that uses rare earth permanent magnets, such as neodymium, is mainly used in an electric motor in recent years, it is desirable to avoid such brushless motors becoming dependent on rare earth permanent magnets in case these rare earth magnets become unavailable.

On the other hand, although a winding field magnet type motor that has a rotor with field windings is well-known, in order to be adapted to a brushless structure, it is necessary to transmit an exciting current supplied to the field windings without direct contact.

In contrast, an exciter that used a rotating transformer is disclosed in Japanese Patent Application Laid-Open Publicaiton No. 2010-166787.

This exciter can transmit exciting current to a secondary side without direct contact from a primary side of the rotating transformer, and can supply electric power to the field windings of a rotor.

However, in a conventional rotating transformer, as shown in FIG. 12, since a large eddy current I shown by an arrow is generated in a circumferential direction of a transformer-core (hereafter, simplified to a core) 100 that has an annular shape, loss of the eddy current becomes a problem.

Especially, when the exciting frequency is raised for miniaturizing the apparatus, there is a problem that the increase in loss of the eddy current becomes remarkable, and decline in transmitting efficiency becomes significant.

The large eddy current I in the circumferential direction can be reduced by dividing the core, which is molded by compressing magnetic powder, in the circumferential direction.

However, since the core mentioned here is only adhered together by compression of the powder, the strength of the core is insufficient, and sufficient reinforcement needs to be prepared especially for use up to a high speed of rotation.

Furthermore, since the magnetic powder that can be obtained at the present moment has low saturation magnetic flux density compared with a common magnetic steel sheet etc., this is also a factor that obstructs the miniaturization of the apparatus.

### SUMMARY

An embodiment provides an exciter of a rotary electric machine equipped with a rotating transformer that can maintain mechanical strength and miniaturize the apparatus.

In an exciter of a rotary electric machine according to a first aspect, the exciter used for a rotary electric machine that has a rotor with field windings that rotates together with a rotating shaft, and supplies exciting current to the field windings includes a rotating transformer that has a set of coil units constituted by winding a coil around an annular transformer-core, the set of coil units is disposed facing each other with a gap therebetween in an axial direction, one of the coil units among the set of coil units is disposed at a static side while another one of the coil units is disposed at a rotation side.

The transformer-core is constituted by a plurality of segments divided equally in a circumferential direction, each of the segments has a laminated structure constituted by laminating plate-like or sheet-like soft magnetic materials, each segment includes an inner wall part disposed at an inner surface of the coil, an outer wall part disposed at an outer surface of the coil, and a base part disposed at a position opposite to the gap of the coil that connects between the inner wall part and the outer wall parts, and at least laminating directions of the outer wall part and the base part are different to each other.

Since the core of the present disclosure is constituted by laminating plate-like or sheet-like soft magnetic materials to form the segments each of which is divided equally in the circumferential direction, mechanical strength is overwhelmingly high as compared with a conventional core manufactured by compressing magnetic powder.

Specifically, since tensile strength is high, sufficient strength to endure high speed rotation is securable.

However, since the laminated sheets of the inner wall part, the outer wall part and the base part are required to all have an identical laminating direction in each segment formed by dividing the core equally, the manufacturing efforts and hence cost increases.

In contrast, for the segments described in the present disclosure, at least the laminating directions of the outer wall part and the base part may be different to each other, in other words, since it is not necessary to match the laminating direction of the outer wall part and the laminating direction the base part, a laminating direction suitable for each part of the segment can be adopted.

In the exciter of the rotary electric machine according to a second aspect, the inner wall part and the base part are formed unitarily as an L-shaped laminated body in which a shape of a cross-section cut along a radial direction of the segment is substantially L-shaped.

The L-shaped laminated body is constituted by laminating the L-shaped soft magnetic materials in a circumferential direction of the segment, and the L-shaped laminated body is formed so that width in the circumferential direction becomes constant from the inner wall part to an outer circumference end part of the base part, and the outer wall part is constituted by laminating the soft magnetic materials in the radial direction of the segment.

In the exciter of the rotary electric machine according to a third aspect, a recessed portion recessed completely through the outer wall part in the laminating direction of the outer wall part with predetermined opening width in the circumferential direction is formed in a position opposite to the gap of an end surface in the axial direction of the outer wall part or a through-hole that penetrates a position opposite to the gap end part in the lamination direction is formed in the outer wall part, and the L-shaped laminated body is constituted by inserting an outer circumference end part of the base part into the recessed portion or the through-hole of the outer wall part.

In the exciter of the rotary electric machine according to a fourth aspect, the outer wall part of the segment has a shape of an arc that has an equal distance from a center of the transformer-core when seen from the axial direction, and the transformer-core has an annular circumference shape when seen from the axial direction.

In the exciter of the rotary electric machine according to a fifth aspect, the outer wall part of the segment has a shape of a flat plate that intersects perpendicularly with the radial direction of the segment when seen from the axial direction, and the transformer-core has a polygon circumference shape when seen from the axial direction.

In the exciter of the rotary electric machine according to a sixth aspect, a reinforcement member that has a higher electric resistivity than the soft magnetic material is attached to the outer surfaces of the plurality of segments of the core.

In the exciter of the rotary electric machine according to a seventh aspect, a fixing member formed with a material that has a higher electric resistivity than the soft magnetic material and which is disposed in a space formed between the base parts of the transformer-core adjoining in the circumferential direction.

In the exciter of the rotary electric machine according to an eighth aspect, the laminations of the segment are adhered together by permeating adhesives between the laminations of the laminated plate-like or sheet-like soft magnetic materials.

In the exciter of the rotary electric machine according to a ninth aspect, the transformer-core is electrically insulated between the outer wall parts of the segments adjoining each other in the circumferential direction.

In the exciter of the rotary electric machine according to a tenth aspect, the plate-like or sheet-like soft magnetic material that constitutes the segment is a magnetic steel sheet or an amorphous metallic foil.

### BRIEF DESCRIPTION OF THE DRAWINGS

In the accompanying drawings:

FIG. 1A shows a perspective view of a segment seen from inside in a radial direction of a first embodiment;

FIG. 1B shows a perspective view of the segment seen from outside in the radial direction;

FIG. 2 shows a perspective view of a core;

FIG. 3 shows a perspective view of a set of cores;

FIG. 4 shows a schematic structural diagram of a synchronous motor and a rotating transformer;

FIG. 5 shows a circuit diagram of the synchronous motor and an exciter;

FIG. 6 shows a perspective view of the segment showing a main magnetic flux and an eddy current that flow in a base part;

FIG. 7 shows a perspective view of the segment showing the eddy current that is generated in an inner surface of an outer wall part;

FIG. 8 shows a perspective view of the segment that an outer circumference end part of the base part is inserted into a through-hole formed in an outer wall part, and joined;

FIG. 9 shows a plan view of a static side core in a second embodiment;

FIG. 10 shows a plan view of a rotation side core in the second embodiment;

FIG. 11 shows a plan view explaining a size relation in a radial direction between the outer wall part of the static side core and the outer wall part of the rotation side core in the second embodiment; and

FIG. 12 shows a perspective view of a conventional core where the eddy current generated in a circumferential direction is shown (prior art).

### DETAILED DESCRIPTION OF THE PREFERRED EMBODIMENTS

With reference to the accompanying drawings, hereinafter will be described embodiments of the present disclosure.

### First Embodiment

The first embodiment provides an example that an exciter of the present disclosure is applied to a winding field magnet type synchronous motor.

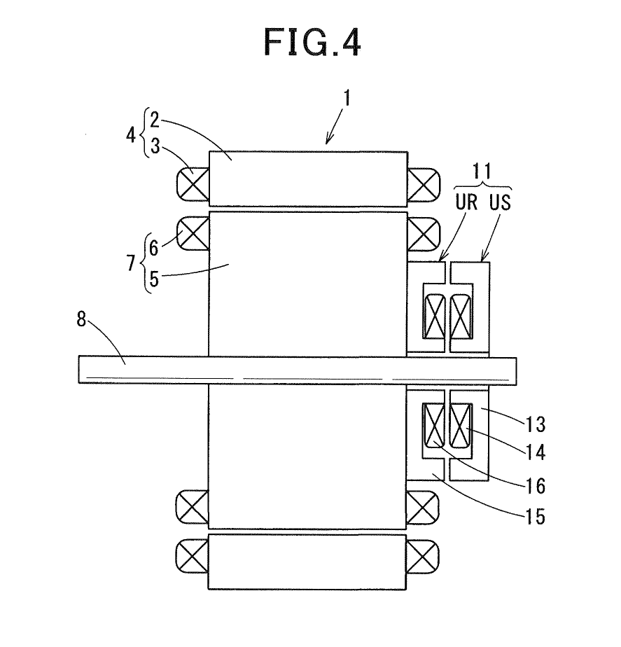

As shown in FIG. 4, a synchronous motor 1 has a stator 4 where armature windings 3 are wound around a stator core 2 and a rotor 7 where field windings 6 are wound around a rotor core 5, and the rotor 7 is supported by a motor rotating shaft 8, and is constituted to be rotatable together with the motor rotating shaft 8.

The stator 4 is fixed to a motor housing (not shown).

The stator core 2 is constituted by laminating a plurality of annular magnetic steel sheets where a plurality of slots is punched on an inner surface in a radial direction at regular intervals in a circumferential direction.

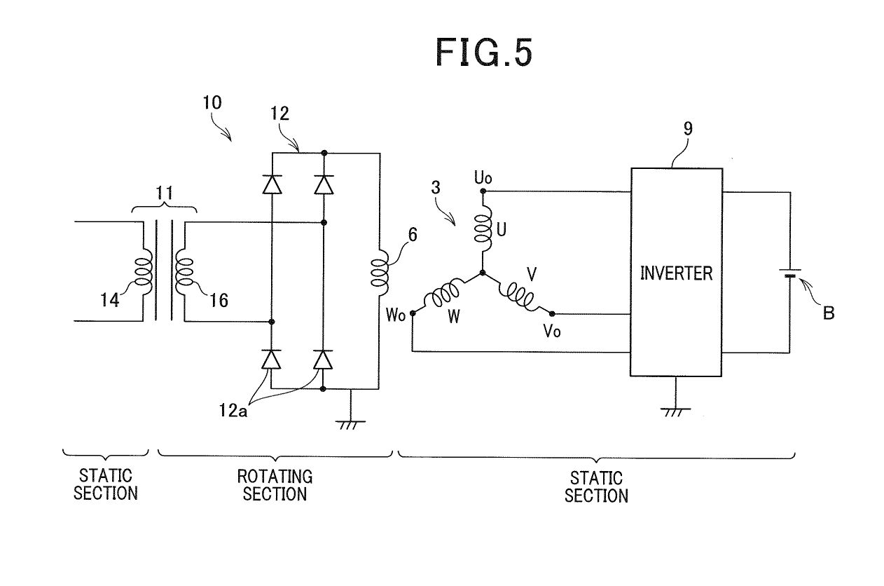

As shown in FIG. 5, the armature windings 3 has a phase winding of three phases (U phase, V phase, W phase) in a star type connection, and each end of the phase windings Uo, Vo, and Wo are connected to an inverter 9.

The inverter 9 is a well-known power converter that converts DC (direct current) power taken out from a battery B into AC (alternating current) power, and supplies it to the armature windings 3.

In addition, a winding specification of the armature windings 3 may be either well-known concentrated winding or distributed winding.

As shown in FIG. 4, the rotor 7 is disposed facing an inner surface in a radial direction of the stator 4 with a predetermined gap.

The rotor core 5 is constituted by laminating a plurality of annular magnetic steel sheets where a plurality of slots is punched on an outer surface in a radial direction at regular intervals in a circumferential direction, and is fixed to an outer surface of the motor rotating shaft 8 by serration fitting etc.

The field windings 6 are wound around the rotor core 5 by the same winding specification as the rotor structure disclosed in Japanese Patent Application Laid-Open Publication No. 2010-166787, for example, and a magnetic pole of the rotor 7 is magnetized by supplying field current (direct current) from the exciter 10 shown in FIG. 5 to form an electromagnet.

Next, the exciter 10 of the present disclosure is explained.

As shown in FIG. 5, the exciter 10 has a rotating transformer 11 that can transmit electric power to a secondary side without direct contact from a primary side, and a power rectifier 12 that converts AC power transmitted to the secondary side into DC power and supplies to the field windings 6 of the rotor 7.

As shown in FIG. 4, the rotating transformer 11 includes a static side unit US and a rotation side unit UR disposed facing each other with a predetermined gap in an axial direction of the motor rotating shaft 8 (horizontal direction in FIG. 4), and both the units US and UR are disposed coaxially with the motor rotating shaft 8.

The static side unit US includes an annular transformer-core (hereafter called a static side core 13) disposed on the outer surface of the motor rotating shaft 8, and a primary coil 14 is wound around the static side core 13. The static side core 13 is fixed to the motor housing with bolts or the like.

In order to avoid contact with the motor rotating shaft 8, a gap is secured between the motor rotating shaft 8 and an inner surface in a radial direction of the static side core 13.

The primary coil 14 is concentrically wound around the static side core 13, and alternating current is supplied from a power supply (not shown). The primary coil 14 is adhered by impregnating adhesives etc., therein.

The rotation side unit UR includes an annular transformer-core (hereafter called a rotation side core 15) disposed on the outer surface of the motor rotating shaft 8, and a secondary coil 16 is wound around the rotation side core 15. The rotation side core 15 is fixed to an end surface in the axial direction of the rotor core 5 with bolts or the like.

In order to suppress a transfer of magnetic flux between the rotation side core 15 and the motor rotating shaft 8, a gap is secured between the motor rotating shaft 8 and an inner surface in a radial direction of the rotation side core 15.

The secondary coil 16 is concentrically wound around the rotation side core 15, and as shown in FIG. 5, the coil 16 is connected to the field windings 6 of the rotor 7 through the power rectifier 12.

This secondary coil 16 is adhered by impregnating adhesives etc., therein.

As shown in FIG. 5, for example, the power rectifier 12 includes a bridge type full-wave-rectification circuit with which four rectifiers (diodes 12a) are connected in a shape of a bridge, and when an alternating current is induced to the secondary coil 16 by supplying an electric power to the primary coil 14, the alternating current is converted into a direct current and supplied to the field windings 6.

In addition, the power rectifier 12 can also be constituted combining a rectification circuit and a smoothing circuit.

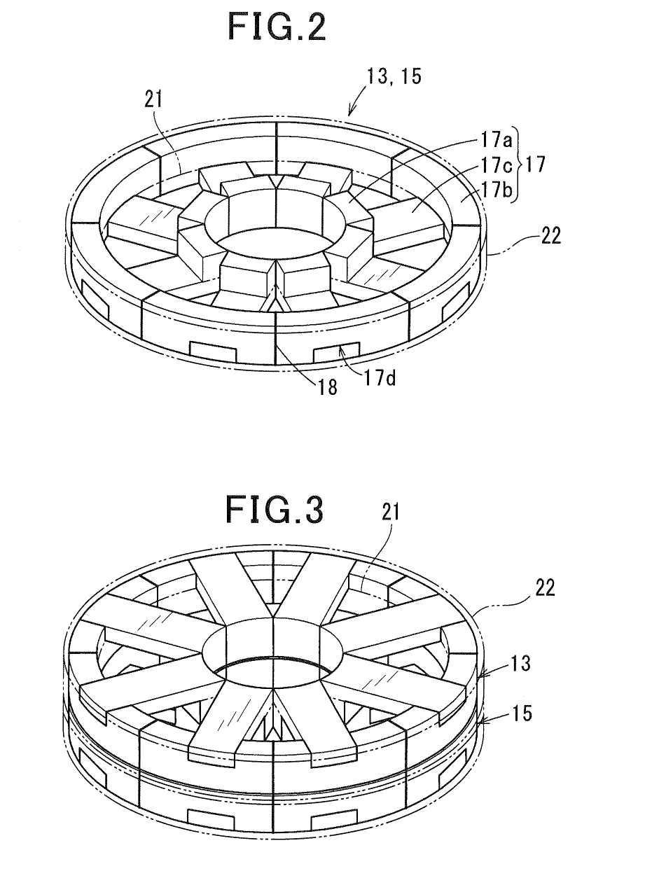

The static side core 13 and the rotation side core 15 disclosed in the first embodiment have the same composition and shape, as shown in FIG. 2 and FIG. 3.

Therefore, common reference numerals are given to components of both the cores 13 and 15 explained in full detail below.

In addition, FIG. 2 shows a common drawing for the static side core 13 and the rotation side core 15, and FIG. 3 is a perspective view in which the static side core 13 and the rotation side core 15 are disposed facing each other with a gap therebetween.

The static side core 13 and the rotation side core 15 are constituted by a plurality of segments 17 divided equally in the circumferential direction (divided into eight segments in FIG. 2).

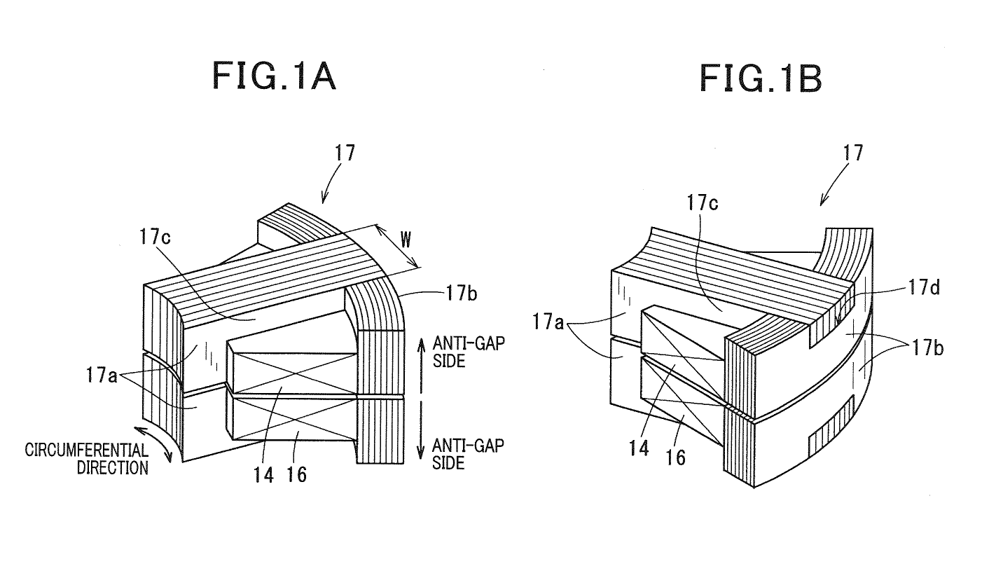

As shown in FIG. 1A and FIG. 1B, each segment 17 includes an inner wall part 17a disposed at inner surfaces of the coils 14 and 16, an outer wall part 17b disposed at outer surfaces of the coils 14 and 16, and a base part 17c disposed at the position opposite to the gap of the coils 14 and 16 that connects between the inner wall part 17a and the outer wall parts 17b.

The segment 17 has a laminated structure constituted by laminating plate-like or sheet-like soft magnetic materials such as magnetic steel sheets, for example. Hereinafter, the laminated structure of the segment 17 is provided.

The inner wall part 17a and the base part 17c are constituted unitarily as an L-shaped laminated body in which a shape of a cross-section cut along the radial direction of the segment 17 has substantially the shape of a letter L.

The L-shaped laminated body is constituted by laminating a plurality of magnetic steel sheets, which are punched in substantially an L shape by pressing, for example, in a circumferential direction of the segment 17a, and as shown in FIG. 1A, the L-shaped laminated body is formed so that width w in the circumferential direction becomes constant from the inner wall part 17a to an outer circumference end part of the base part 17c.

In this case, as shown in FIG. 2, since triangular spaces are formed between the base parts 17c of the segments 17 adjoining in the circumferential direction, fixing members 21 formed with the material that has a higher electric resistivity than the magnetic steel sheet can be disposed in these spaces so that the adjoining base parts 17c can be connected and fixed by the fixing members 21.

The outer wall part 17b has, when seen from the axial direction, a shape of an arc that has an equal distance from centers of the static side core 13 and the rotation side core 15, and as shown in FIG. 1A and FIG. 1B, the outer wall part 17b is constituted by laminating a plurality of magnetic steel sheets, which are bent into an arc-shape, in the radial direction of the segment 17.

As shown in FIG. 1B, a recessed portion 17d is formed in a position opposite to the gap of an end surface of the outer wall part 17b.

The recessed portion 17d is recessed in a whole laminating direction of the outer wall part 17b with predetermined opening width in the circumferential direction.

The L-shaped laminated body mentioned above and the outer wall part 17b constitute a single segment 17 by inserting an outer circumference end part of the base part 17c into the recessed portion 17d formed in the outer wall part 17b and fixed it.

The segment 17 is adhered by permeating adhesives between the laminations of the L-shaped laminated body and the outer wall part 17b.

The static side core 13 and the rotation side core 15 shown in FIG. 2 are constituted by combining the segment 17 mentioned above in an annular shape, and insulating members 18 are sandwiched between the outer wall parts 17b adjoining in the circumferential direction.

That is, the adjoining outer wall parts 17b are electrically insulated by the insulating members 18.

Moreover, reinforcement members 22 that are non-magnetic and also have a higher electrical resistivity than the magnetic steel sheet used for the segment 17 are attached to the outer surfaces of the static side core 13 and the rotation side core 15.

The reinforcement member 22 is made of fiber resin, a reinforcing tape, etc., for example, and holds the outer surfaces of all the segments 17 put together in a circle, i.e., the outer surfaces of all the outer wall parts 17b annularly disposed sandwiching the insulating member 18 therebetween.

### Function and Effect of the First Embodiment

Since the static side core 13 and the rotation side core 15 are constituted by laminating magnetic steel sheets to form the segments 17 each of which is divided equally in the circumferential direction, mechanical strength is much higher compared with a conventional core manufactured by compressing magnetic powder.

Specifically, since tensile strength is high, strength that can endure high rotation speed is securable.

Moreover, since the saturation magnetic flux density of a common magnetic steel sheet is more than 1.8 T and is higher than the saturation magnetic flux density (about 1.5-1.6 T) of the magnetic powder that can be obtained at present, it is advantageous also to the miniaturization of the static side core 13 and the rotation side core 15.

Since the spaces are formed between the base parts 17c adjoining in the circumferential direction in the static side core 13 and the rotation side core 15 disclosed in the first embodiment, a structure that connects and fixes the adjoining base parts 17c through the fixing members 21 by disposing the fixing members 21 in which electric resistivity is higher than the magnetic steel sheet into these spaces can also be adopted.

In this case, it is possible to raise intensity further without increasing the sizes of the static side core 13 and the rotation side core 15.

When the segment 17 constituted by laminating the magnetic steel sheets is fastened between laminations by means such as welding and a crimping, a path of the eddy current is formed in the lamination direction through a fastened portion.

On the other hand, since the adhesives are permeated between laminations of the segment 17 to adhere the laminations in the first embodiment, the eddy current does not flow in the lamination direction.

In addition, it is ideal to perform permeation of the adhesives in a vacuum.

Moreover, since the adjoining outer wall parts 17b of the static side core 13 and the rotation side core 15 are electrically insulated by the insulating members 18 that are sandwiched between the outer wall parts 17b adjoining in the circumferential direction in the state where the plurality of the segment 17 are combined in the annular shape, the eddy currents which flow around the outer wall part 17b can be separated reliably.

Furthermore, since the outer surfaces of all the segments 17 assembled annularly of the static side core 13 and the rotation side core 15, i.e., the outer surfaces of all the outer wall parts 17b annularly disposed on both sides of the insulating member 18 are supported by the reinforcement members 22 with high electric resistivity, endurance in terms of centrifugal strength and reduction of the eddy current can be compatible.

Since the inner wall part 17a and the outer wall part 17b are disposed unitarily as the L-shaped laminated body in the segment 17 explained in the first embodiment, while the L-shaped laminated body and the outer wall part 17b are constituted separately, the lamination direction of the L-shaped laminated body and the lamination direction of the outer wall part 17b need not to be matched.

That is, as shown in FIG. 1A and FIG. 1B, the L-shaped laminated body is constituted by laminating the L-shaped magnetic steel sheets in the circumferential direction of the segment 17, and the outer wall part 17b is constituted by laminating the magnetic steel sheets bent into the arc-shape in the radial direction of the segment 17.

By this, since the lamination direction suitable for each part of the segment 17 is employable, it becomes possible to simplify the lamination process of the segment 17 and to reduce manufacturing steps.

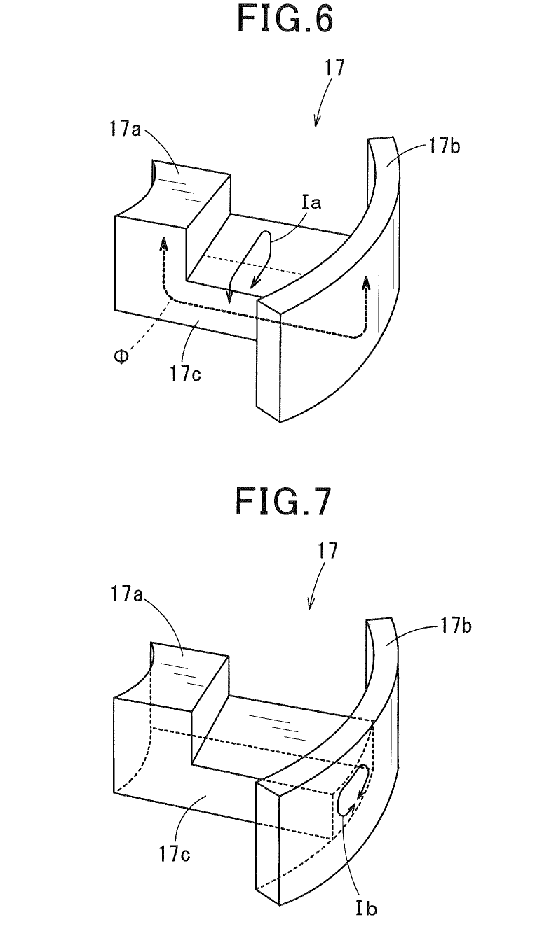

Moreover, according to the laminated structure mentioned above, as shown in FIG. 6, the eddy current Ia that flows around the inside of the base part 17c can be reduced without blocking a main magnetic flux φ that passes along the base part 17c of the segment 17 radially, and the eddy current that flows around the inner wall part 17a and the outer wall part 17b can be reduced effectively.

Although the segment 17 disclosed in the first embodiment is constituted by combining the L-shaped laminated body and the outer wall part 17b, it became clear in research that when the outer circumference end surface of the base part 17c is fixed by contacting to the inner surface of the outer wall part 17b, as shown in FIG. 7, the eddy current Ib shown with an arrow in FIG. 7 is generated in the inner surface of the outer wall part 17b where the outer circumference end surface of the base part 17c is contacted.

On the other hand, since in the segment 17 disclosed in the first embodiment, the outer circumference end surface of the base part 17c does not contact the inner surface of the outer wall part 17b, but instead the outer circumference end part of the base part 17c is inserted into in the recessed portion 17d formed in the end surface of the outer wall part 17b, the eddy current Ib as shown in FIG. 7 is not generated.

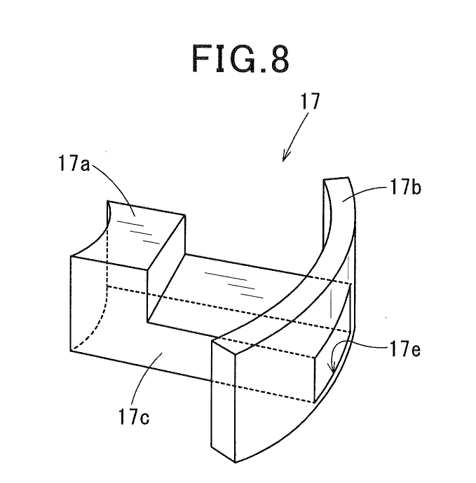

In addition, instead of forming the recessed portion 17d in the outer wall part 17b, a composition that forms a rectangular through-hole 17e that penetrates the outer wall part 17b in the lamination direction, and where the outer circumference end part of the base part 17c is inserted in this through-hole 17e and fixed thereto may be employed, for example, as shown in FIG. 8.

### Second Embodiment

This second embodiment is an example that circumference shapes of the static side core 13 and the rotation side core 15 are formed into regular polygon, and the laminated structure of each segment 17 formed by dividing both the cores 13 and 15 equally is the same as that of the first embodiment.

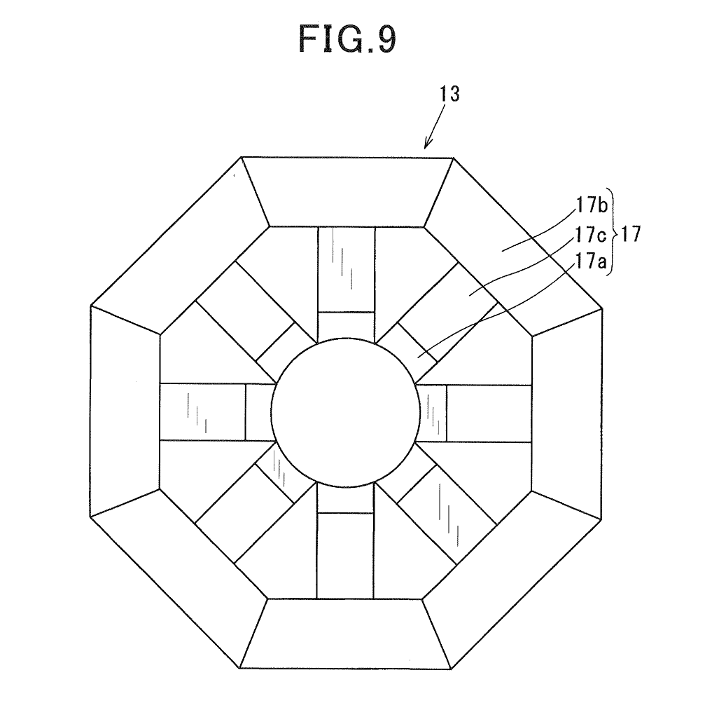

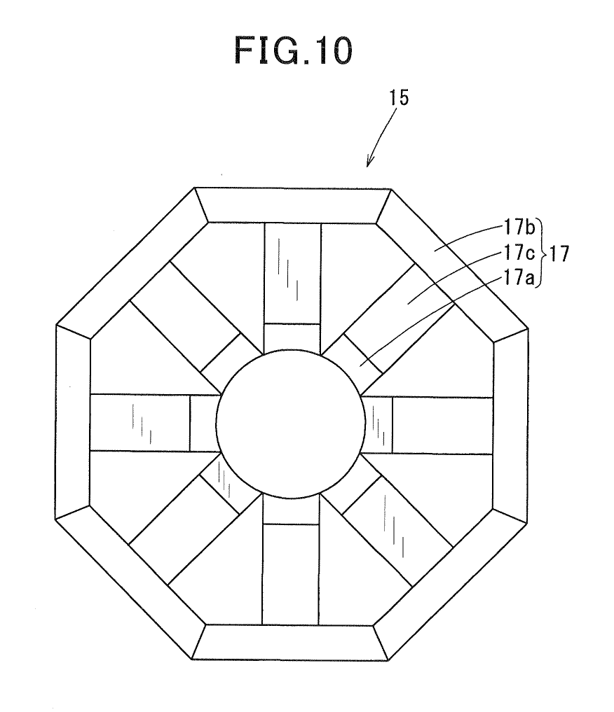

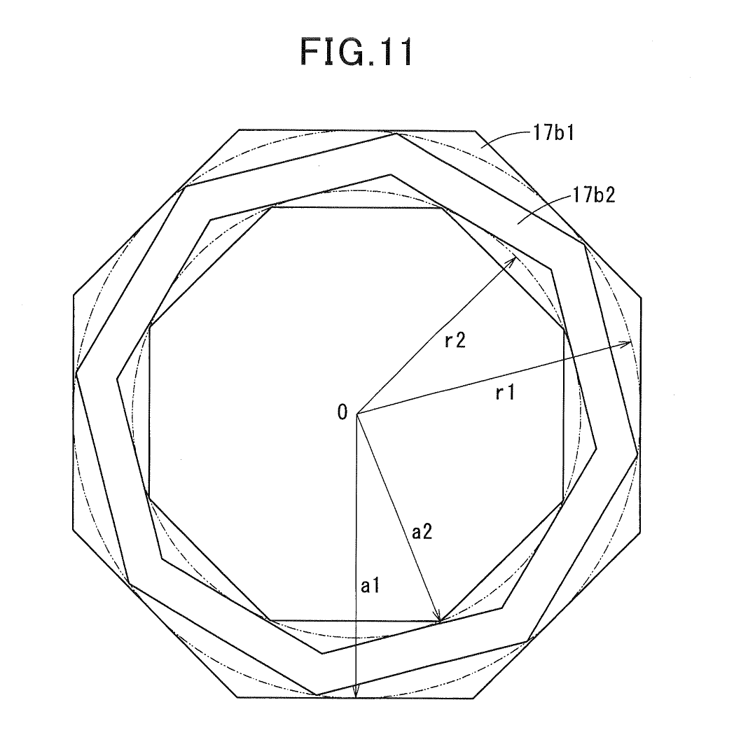

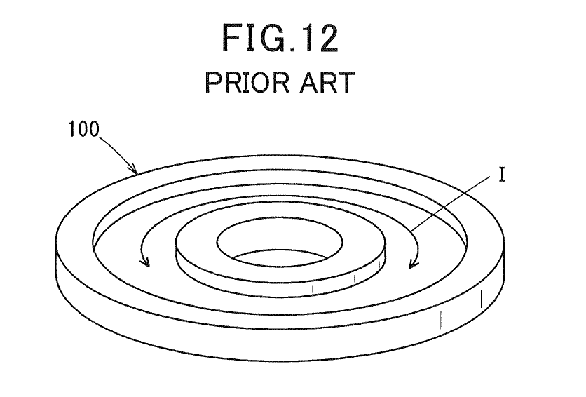

In each segment 17 that constitutes the static side core 13 and the rotation side core 15, a shape of the outer wall part 17b seen from the axial direction is a flat plate like shape that intersects perpendicularly with the radial direction of the segment 17, and by combining the segment 17 that has the flat plate like outer wall part 17b in an annular shape, as shown in FIG. 9 and FIG. 10, the static side core 13 and the rotation side core 15 having the shape of a regular polygon are formed.

However, when adopting the transformer-core having the regular polygon circumference shape, since an usable area where a transfer side of magnetic flux faces when the rotation side core 15 rotates decreases if both outer wall parts 17b of the static side core 13 and the rotation side core 15 are designed in the same size, it is necessary to thicken lamination thickness (radial size) of one of the outer wall parts 17b.

Hereinafter, an outer wall part of the segment 17 that constitutes the static side core 13 is given a reference number 17b1 and an outer wall part of the segment 17 that constitutes the rotation side core 15 is given a reference number 17b2.

In this case, since it is more desirable to make the rotation side core 15 small, as shown in FIG. 11, a radius r1 of a circumscribed circle (outer circle shown with a two-dot chain line in FIG. 11) of the regular polygon formed by the outer wall part 17b2 is configured equal to a distance al from a center O of both the cores 13 and 15 to an outside surface of the outer wall part 17b1, and a radius r2 of an inscribed circle (inner circle shown with a two-dot chain line in FIG. 11) of the regular polygon formed by the outer wall part 17b2 is configured equal to a distance a2 from the center O of the static side cores 13 and 15 to an inner corner part of the regular polygon formed of the outer wall part 17b1.

According to the composition mentioned above, since it is not necessary to bend the outer wall parts 17b1 and 17b2 of the segment 17, remaining stress does not occur and it is effective to prevent degradation of magnetism.

### Modification

Although the first embodiment discloses the example of the segment 17 constituted by laminating magnetic steel sheets, an amorphous metallic foil is also employable as an example other than the magnetic steel sheets, for example.

Moreover, although the first embodiment discloses that numbers of partitions of the static side core 13 and the rotation side core 15 are the same (divided into eight in FIG. 2), a composition that the numbers of partitions of both the cores 13 and 15 differ may be used.

Further, although the gap is secured between the rotation side core 15 and the motor rotating shaft 8 in the first embodiment, a non-magnetic component can also be disposed between the rotation side core 15 and the motor rotating shaft 8 instead of providing the gap.

Furthermore, although the first embodiment discloses the example that the exciter 10 of the present disclosure is applied to the synchronous motor 1, it is also applicable to a synchronous generator.

What is claimed is:

1. An exciter used for a rotary electric machine that has a rotor with field windings that rotates together with a rotating shaft, and supplies exciting current to the field windings, comprising:
a rotating transformer that has a set of coil units constituted by winding a coil around an annular transformer-core, the set of coil units is disposed facing each other with a gap therebetween in an axial direction, one of the coil units among the set of coil units is disposed at a static side while another one of the coil units is disposed at a rotation side; wherein,
the transformer-core is constituted by a plurality of segments divided equally in a circumferential direction,
each of the segments has a laminated structure constituted by laminating plate-like or sheet-like soft magnetic materials,
each segment comprises an inner wall part disposed at an inner surface of the coil, an outer wall part disposed at an outer surface of the coil, and a base part disposed at a position opposite to the gap of the coil that connects between the inner wall part and the outer wall parts, and
at least laminating directions of the outer wall part and the base part are different to each other.

2. The exciter of the rotary electric machine according to claim 1, wherein,
the inner wall part and the base part are formed unitarily as an L-shaped laminated body in which a shape of a cross-section cut along a radial direction of the segment is substantially L-shaped,
the L-shaped laminated body is constituted by laminating the L-shaped soft magnetic materials in a circumferential direction of the segment, and the L-shaped laminated body is formed so that width in the circumferential direction becomes constant from the inner wall part to an outer circumference end part of the base part, and
the outer wall part is constituted by laminating the soft magnetic materials in the radial direction of the segment.

3. The exciter of the rotary electric machine according to claim 2, wherein,
a recessed portion recessed completely through the outer wall part in the laminating direction of the outer wall part with predetermined opening width in the circumferential direction is formed in a position opposite to the gap of an end surface in the axial direction of the outer wall part or a through-hole that penetrates a position opposite to the gap end part in the lamination direction is formed in the outer wall part;
and the L-shaped laminated body is constituted by inserting an outer circumference end part of the base part into the recessed portion or the through-hole of the outer wall part.

4. The exciter of the rotary electric machine according to claim 1, wherein,
the outer wall part of the segment has a shape of an arc that has an equal distance from a center of the transformer-core when seen from the axial direction, and
the transformer-core has an annular circumference shape when seen from the axial direction.

5. The exciter of the rotary electric machine according to claim 1, wherein,
the outer wall part of the segment has a shape of a flat plate that intersects perpendicularly with the radial direction of the segment when seen from the axial direction, and
the transformer-core has a polygon circumference to shape when seen from the axial direction.

6. The exciter of the rotary electric machine according to claim 1, wherein,
a reinforcement member that has a higher electric resistivity than the soft magnetic material is attached to the outer surfaces of the plurality of segments of the core.

7. The exciter of the rotary electric machine according to claim 2, wherein,
a fixing member formed with a material that has a higher electric resistivity than the soft magnetic material and which is disposed in a space formed between the base parts of the transformer-core adjoining in the circumferential direction.

8. The exciter of the rotary electric machine according to claim 1, wherein,
the laminations of the segment are adhered together by permeating adhesives between the laminations of the laminated plate-like or sheet-like soft magnetic materials.

9. The exciter of the rotary electric machine according to claim 1, wherein,
the transformer-core is electrically insulated between the outer wall parts of the segments adjoining each other in the circumferential direction.

10. The exciter of the rotary electric machine according to claim 1, wherein,
the plate-like or sheet-like soft magnetic material that constitutes the segment is a magnetic steel sheet or an amorphous metallic foil.
